(19) United States
(12) Patent Application Publication
(10) Pub. No.: US 2024/0288221 A1
(43) Pub. Date: Aug. 29, 2024

(54) HEATING ASSEMBLY AND INDUSTRIAL APPARATUS FOR THE FIRING OF CERAMIC ARTICLES

(71) Applicant: SACMI FORNI & FILTER S.P.A., IMOLA (IT)

(72) Inventors: Pier Francesco VACCARI, IMOLA (IT); Alberto TORO, IMOLA (IT)

(21) Appl. No.: 18/573,194

(22) PCT Filed: Jun. 21, 2022
(86) PCT No.: PCT/IB2022/055733

§ 371 Date: Dec. 21, 2023

(30) Foreign Application Priority Data
Jun. 22, 2021 (IT) 102021000016334
Jun. 22, 2021 (IT) 102021000016352

(51) Int. Cl. F27D 11/02; F27B 9/36

(52) U.S. Cl. CPC F27D 11/02; F27B 9/36; F27B 2009/3638

(57) ABSTRACT

An industrial apparatus and a heating assembly for the firing of ceramic articles, which is installable in a kiln and comprises: an electric heater, comprising a tubular casing, a feeding duct to feed a gas comprising air, at least one electric heating element which can be operated in order to heat the gas; and a tubular discharge element extending from the tubular casing, is configured to be flown through by the gas exiting the electric heater and comprises at least a first leading outlet to lead at least part of said gas towards said firing chamber, which first leading outlet has a through-hole with an equivalent diameter smaller than or equal to approximately 25 mm.

### CROSS-REFERENCE TO RELATED APPLICATION

This patent application claims priority from Italian patent application no 102021000016334 filed on Jun. 22, 2021 and from the Italian Patent Application No. 102021000016352 filed on Jun. 22, 2021, the entire disclosures of which are incorporated herein by reference.

### TECHNICAL FIELD OF THE INVENTION

The present invention relates to a heating assembly and apparatus for the firing of ceramic articles. In particular, the present invention is advantageously, but not exclusively, applied to the firing of ceramic articles to obtain tiles, which the following description will make explicit reference without thereby losing generality.

### BACKGROUND ART

The firing of ceramic articles to obtain tiles generally takes place in tunnel kilns, delimited by two opposite walls and a roof.

Such kilns are usually heated by two sets of burners typically running on methane gas, each arranged on one side of the tunnel. These burners are usually located on the side walls of the tunnel on several levels and face the opposite wall, and the ceramic articles are usually transported on a large conveyor consisting of a series of ceramic rollers.

The firing cycle of ceramic articles is designed with great precision and involves: heating the ceramic articles starting from the kiln entrance, holding them inside the firing chamber at a predefined temperature and cooling them in a controlled manner before reaching the kiln exit. Consequently, it is important to ensure that the temperature inside the firing chamber is uniform throughout the width of the kiln. For this purpose, different types of industrial burners have been developed, as well as different burner arrangements within industrial apparatuses, in order to achieve an increasingly constant temperature within the firing chamber.

However, ceramic burners of the known type are essentially fueled with fossil fuels (methane, LPG), which, although, on the one hand, allow NOx emissions to be reduced through normal combustion, on the other hand lead to an anti-ecological exploitation of non-renewable resources and emission of CO2 and of all other combustion waste products.

In an attempt to overcome these problems, methods have been developed for electrically heating kilns for the firing of ceramic articles, involving, for example, the installation of heating rods or heating conductors in the kiln compartment to radiate heat and heat the kiln itself.

However, even such known firing methods have some disadvantages. One of the main disadvantages is related to the aggressive nature of the fumes generated by the firing of the ceramic articles, especially in the pre-heating area of the kiln itself, which induce rapid erosion of the heating rods or heating conductors installed in the kiln, thus forcing frequent maintenance or replacement of such heating elements. In order to try to overcome such a problem, such heating rods or heating conductors are generally installed only in the firing area of the kiln, where the fumes produced are not highly chemically aggressive, while in the pre-heating area, industrial burners of the known type are used.

Furthermore, electrically heating kilns for the firing of ceramic articles is more expensive than oil or gas, regardless of whether the electricity is used from the grid or internally.

A further disadvantage of the known methods for electrically heating kilns for the firing of ceramic articles is the often excessive radiation effect, which does not allow for uniform heat distribution in large combustion chambers.

Yet another disadvantage of the known methods for electrically heating kilns for the firing of ceramic articles is related to the impossibility of firing the body of the ceramic article uniformly throughout t its section. In particular, with the known methods, only ceramic articles up to 6 mm thick can be fired evenly throughout the thickness.

Aim of the present invention is to make a heating assembly and an industrial apparatus for the firing of ceramic articles which make it possible to overcome, at least partially, the drawbacks of the prior art, while at the same time being easy and cheap to realise and resulting in at least a reduction of CO2 emissions.

### SUMMARY OF THE INVENTION

According to the present invention, a heating assembly and an industrial apparatus for the firing of ceramic articles as claimed in the attached independent claims, and preferably, in any one of the claims dependent directly or indirectly on the mentioned independent claims, are put forth.

The claims describe preferred embodiments of the present invention forming an integral part of the present description.

### BRIEF DESCRIPTION OF THE DRAWINGS

The invention will now be described with reference to the accompanying drawings, which illustrate some non-limiting embodiments, wherein:

FIG. 1 represents a schematic, front section view of an industrial apparatus for the firing of ceramic articles according to an embodiment of the present invention;

FIGS. 2, 2A, 4, 6, 8 and 10 are perspective views of a heating assembly according to different embodiments of the present invention;

FIG. 3 is a cross-section front view of the heating assembly of FIG. 2 installed in a kiln for the firing of ceramic articles;

FIG. 3A is a cross-section front view of the heating assembly of FIG. 2A installed in a kiln for the firing of ceramic articles;

FIG. 5 is a cross-section front view of the heating assembly of FIG. 4 installed in a kiln for the firing of ceramic articles;

FIG. 5A illustrates two side views of a part of the heating assembly in FIG. 4 from two different angles;

FIG. 7 is a cross-section front view of the heating assembly of FIG. 6 installed in a kiln for the firing of ceramic articles;

FIG. 7A illustrates two side views of a part of the heating assembly in FIG. 6 from two different angles;

FIG. 9 is a cross-section front view of the heating assembly of FIG. 8 installed in a kiln for the firing of ceramic articles;

FIG. 9A illustrates two side views of a part of the heating assembly in FIG. 8 from two different angles;

FIG. 11 is a cross-section front view of the heating assembly of FIG. 10 installed in a kiln for the firing of ceramic articles;

FIG. 11A is an enlarged scale view of a part of the heating assembly in FIG. 11;

FIG. 12 is a perspective view of a discharge element forming part of a heating assembly according to a further embodiment of the present invention;

FIG. 13 is a side section view of the discharge element of FIG. 12;

FIG. 14 is a graph showing the temperature variation inside the firing chamber of the kiln as a function of the distance from the point where the hot gas enters the kiln (the abscissa shows the distance, the ordinate shows the temperature); and

FIG. 15 is a graph showing the variation of the flowing-out speed, within a firing chamber of a kiln, of a hot gas as a function of the distance from the point where the hot gas is led into a firing chamber (the abscissa shows the distance, the ordinate the temperature).

### DESCRIPTION OF PREFERRED EMBODIMENTS OF THE INVENTION

In the accompanying figures, the reference number 1 globally denotes a heating assembly for the firing of ceramic articles T according to a first aspect of the present invention.

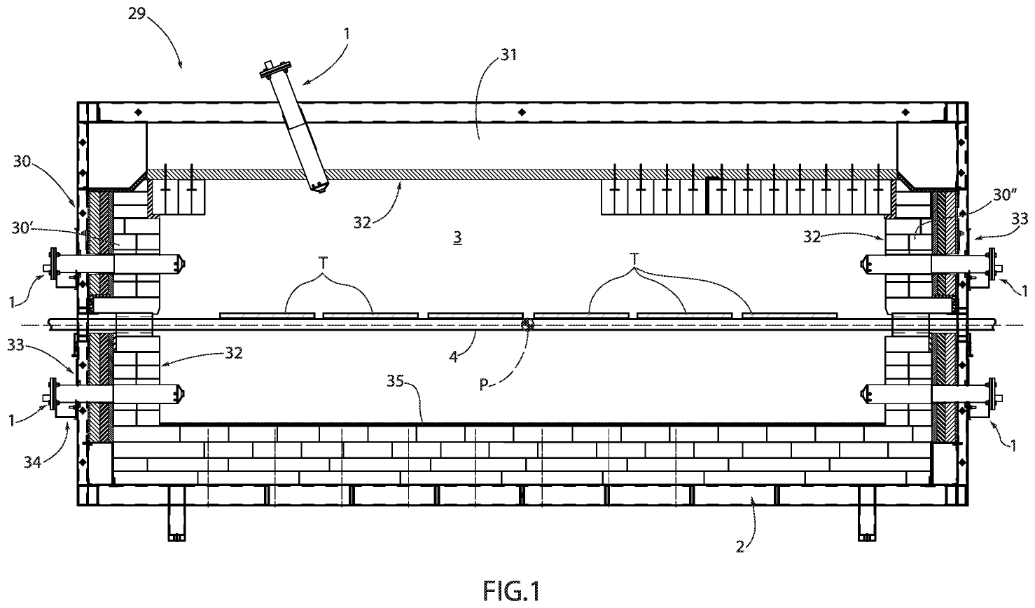

In detail, in the present specification, ceramic articles T are understood to mean any type of article made of ceramic material that requires at least one firing cycle in an industrial kiln 2 (such as the one partially illustrated in FIG. 1), e.g. ceramic slabs or tiles.

The heating assembly 1 may be installed in an industrial kiln 2, in particular in a tunnel kiln 2, comprising a firing chamber 3.

In particular, as schematically illustrated in FIG. 1, advantageously but not limitedly, while firing, the ceramic articles T are moved by a transport system 4 along a conveying path P (schematically illustrated in FIG. 1 and extending orthogonally to the plane visible in FIG. 1).

According to some advantageous but non-limiting embodiments, the transport system 4 comprises a series of rollers arranged in succession along a direction parallel to the conveying path P, on which the non-fired ceramic articles T to be fired are arranged, preferably in an orderly fashion.

In detail, advantageously but not limitedly, the transport system 4 comprises a plurality of ceramic rollers (possibly also moving at different speeds to differentiate the firing of the articles) arranged in succession along the conveying path P (i.e. along the direction parallel to the conveying path P) so as to define a conveying plane intended to receive the ceramic articles T and move them along conveying path P.

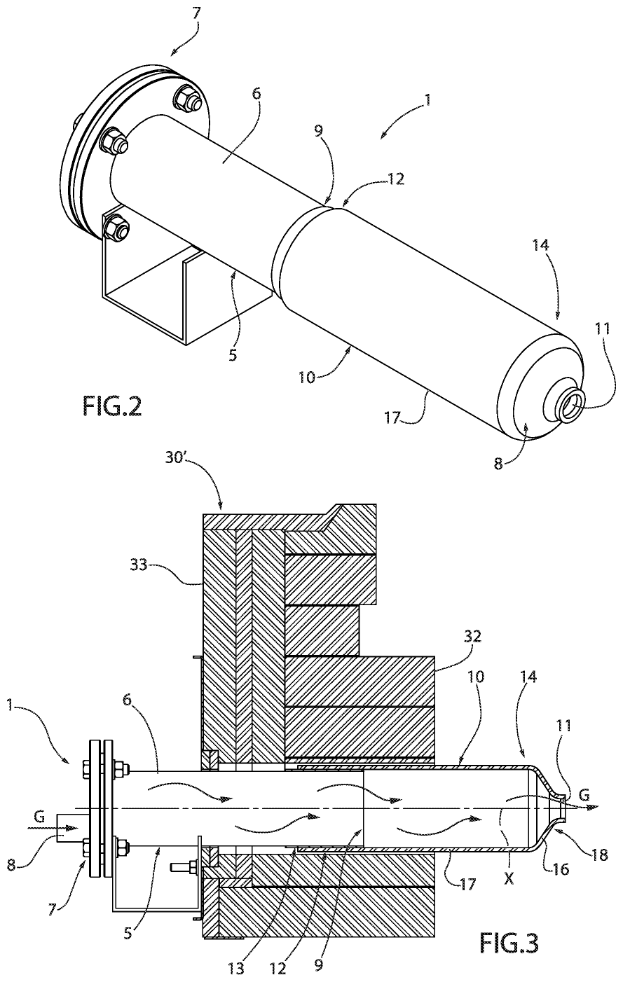

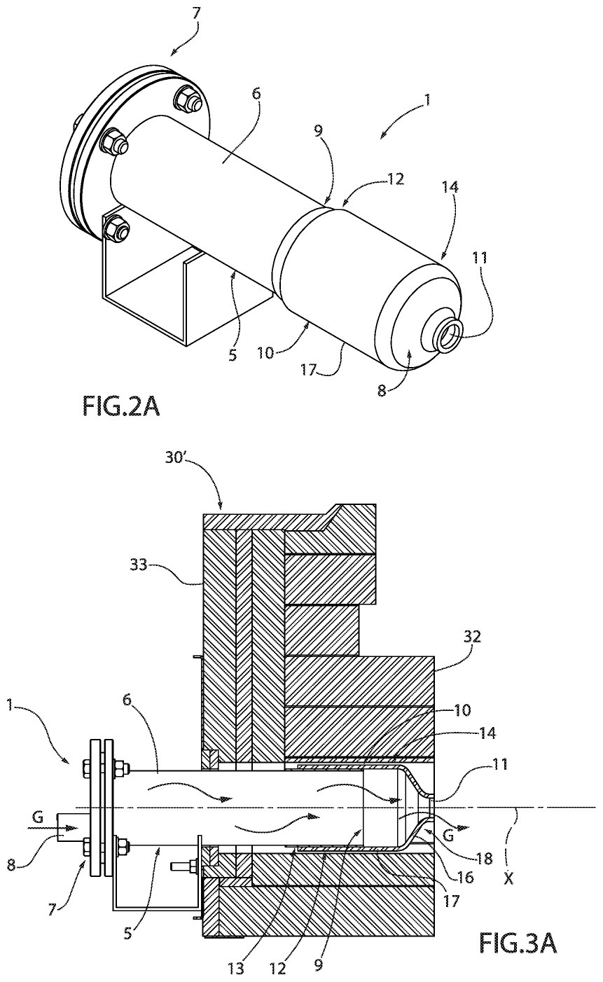

Referring in particular to FIGS. 2 to 11, advantageously but not limitedly, the heating assembly 1 comprises an electric heater 5, comprising, in turn, a tubular casing 6 having at one end 7 a feeding duct 8 to feed a gas G (schematically illustrated with arrows in FIGS. 3, 3A, 5, 7, 9 and 11) inside the tubular casing 6 and at least one electric heater element (not illustrated in the accompanying figures) extending inside the tubular casing 6 and operable to heat, by Joule effect, the gas G.

In detail, advantageously, the gas G comprises (in particular, consists of) ambient air with, for example, at least 21% oxygen.

Advantageously, but not limitedly, the electric heater 5 further comprises at least one support (not visible in the appended figures) attached inside the tubular casing 6 and configured to support at least the electric heater element so as to keep it stationary with respect to the tubular casing 6.

Such an arrangement of the electric heating element within the casing 6 protects the electric heating element from the chemical aggression of any fumes and/or waste gases from the firing chamber 3, increasing the service life of the heating assembly 1 compared to the known electric heating assemblies for the firing of ceramic articles T.

According to some advantageous but non-exclusive embodiments, the mentioned support comprises (in particular, consists of) a rod; even more advantageously, a plurality of rods arranged to define between them a plurality of hollow channels. Advantageously but not limitedly (in this case), the electric heater element comprises (in particular consists of) an electric wire, such as a Kanthal wire, wound around each/the rod and configured to heat by the Joule effect the gas G flowing through the tubular casing 6.

According to alternative embodiments, the support element comprises a plurality of pierced spacers (not visible in the appended figures) extending radially with respect to the tubular casing 6 and following one another along a longitudinal axis X of the tubular casing 6 itself so as to define a plurality of longitudinal channels that are open at least at the ends.

Furthermore, advantageously but not limitedly, the electrical heater element comprises (in particular, consists of) an electric wire, such as a Kanthal wire, which extends through the holes, e.g. helically wound into the several adjacent holes, and configured to heat by the Joule effect the gas G passing through the tubular casing 6.

According to some advantageous but non-limiting embodiments, the electric heater 5 further comprises an insulating layer (not visible in the appended figures) arranged at an end 9 of the tubular casing 6, opposite the end 7, and provided with an opening (not visible in the appended figures) configured to allow the gas G to flow out of the tubular casing 6. Advantageously, but not limitedly, such opening is configured to fluidically connect the electric heater 5 with a tubular discharge element 10, which will be better described below.

Advantageously but not limitedly (according to some embodiments not illustrated), the heating assembly 1, in particular the electric heater 5 further comprises at least one temperature control device (not illustrated) and advantageously comprising at least one thermocouple for detecting the temperature (of the gas G) inside the electric heater 5. Alternatively or in combination, the heating assembly 1, in particular the electric heater 5 additionally comprises at least a control unit (not illustrated) to control (in a known manner), possibly depending on the data recorded by the temperature control device, the operation of the electric heater 5.

According to some advantageous but non-limiting embodiments, the electric heater 5 is a commercially known product described in one of the following Patent documents WO2020193479, EP3721150 and EP3721149.

Advantageously, but not limitedly, the heating assembly 1 further comprises a tubular discharge element 10 extending from the tubular casing 6 of the electric heater 5, on the opposite side relative to the feeding duct 8 (in particular, extending from the end 9 of the electric heater 5), is configured to receive and to be flown through by the gas G flowing out of the electric heater 5, and comprises at least one leading outlet 11 for leading at least part of the aforementioned gas G towards the outside of the tubular discharge element 10 (in particular, towards the outside of the heating assembly 1; even more particularly, in use, towards said firing chamber 3 of the kiln 2).

Advantageously, such leading outlet 11 has a through-hole with an equivalent diameter smaller than or equal to approximately 25 mm. More advantageously, but not limitedly, the through-hole of the leading outlet 11 has an equivalent diameter smaller than or equal to about 20 mm; in particular, smaller than or equal to about 5 mm. Alternatively or in combination, even more advantageously but not limitedly, the through-hole of at least one leading outlet 11 is greater than or equal to about 15 mm, in particular about 10 mm.

It should be noted that in this text, the expression “equivalent diameter” of a through hole must be interpreted as the diameter of a circle having the same area as the through hole.

In use, such size of the outlet 11 allows to increase the speed at which the aforementioned gas G, once heated, is led from the tubular discharge element 10 into the firing chamber 3. This results in a greater linearization of the gas flow G inside the firing chamber 3, which allows for a more uniform temperature within the firing chamber 3 itself. In addition, such size determines an increase in turbulent movements within the tubular discharge element 10 with a consequent facilitation of the heat exchange between the electric heater element and the gas G.

Advantageously but not necessarily (as illustrated in the non-limiting embodiments of FIGS. 2 to 11), the tubular discharge element 10 comprises an end portion 12 coupled to a part 13 of the tubular casing 6 and an end portion 14 opposite the end portion 12.

Advantageously but not limitedly (as illustrated in the non-limiting embodiments in FIGS. 2 to 11), the outlet 11 is arranged at the end portion 14.

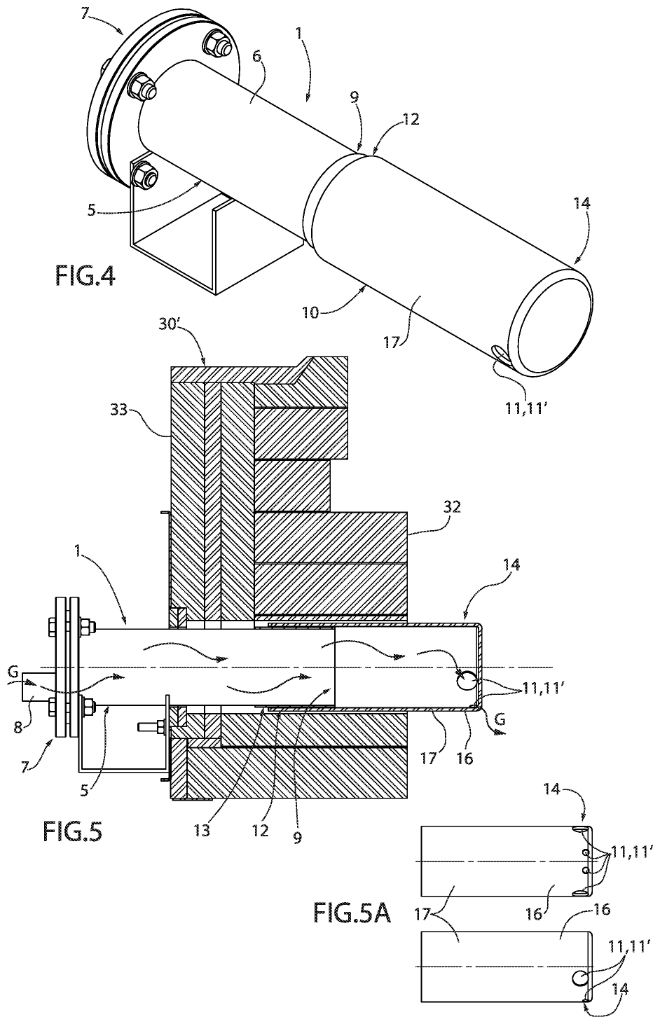

More precisely, (as will be more fully explained below), according to some non-limiting embodiments (such as those illustrated in FIGS. 2, 2A, 3, 3A, 6, 7, 7A, 8, 9, 9A, 10 and 11), the leading outlet 11 is arranged along the axis X of longitudinal symmetry of the tubular discharge element 10; more advantageously, the through-hole of the leading outlet 11 is arranged along the axis X of longitudinal symmetry; even more advantageously, such through-hole of the leading outlet 11 is centred with respect to the axis X i.e. of longitudinal symmetry of the tubular discharge element 11. Alternatively (according to other non-limiting embodiments, such as those illustrated in FIGS. 4, 5, 5A, 12 and 13), the leading outlet 11 is arranged on a wall 16 of the end portion 14.

Advantageously but not limitedly (as in the embodiments illustrated), the discharge element 10 is substantially coaxial to the tubular casing 6. In detail, the tubular discharge element 10 comprises a longitudinal axis X of symmetry, which advantageously but not limitedly coincides with (i.e. lies on the same straight line as) the longitudinal axis X of symmetry of the tubular casing 6.

According to some advantageous but not limiting embodiments, the tubular discharge element 10 comprises at least one further leading outlet 11′ to lead at least one (respective) further part of the gas G to the outside of the tubular discharge element 10 (in particular, to the outside of the heating assembly 1; even more particularly, in use, towards the firing chamber 3 of the kiln 2).

Even more advantageously (as in the non-limiting embodiments illustrated in FIGS. 4, 5, 5A; 6, 6, 7A, 8, 9, 9A, 12 and 13), the tubular discharge element 10 comprises a plurality of further leading outlets 11′ for leading at least one (respective) further part of the gas G towards the outside of the tubular discharge element 10 (in particular, to the outside of the heating assembly 1; even more particularly, in use, towards the firing chamber 3 of the kiln 2).

Advantageously, (also) the further 11′ leading outlet, or each of the further leading outlets 11′, has a respective through-hole with an equivalent diameter smaller than or equal to approximately 25 mm (in particular, smaller than or equal to approximately 20 mm). Advantageously, but not limitedly, the further leading outlet 11′ (or each of the further leading outlets 11′) is also arranged at the end portion 14.

According to some non-limiting embodiments, such as those illustrated in FIGS. 2, 3, 6, 7, 7A, 8, 9 and 9A, (when provided), the further leading outlet 11′, or each of the further leading outlets 11′, is arranged on the wall 16 of the end portion 14. More advantageously, but not limitedly, the through-hole of the further leading outlet 11′, or of each of the further leading outlets 11′, has an equivalent diameter smaller than or equal to approximately 20 mm; in particular, smaller than or equal to approximately 15 mm. Even more advantageously, the through-hole of the further leading outlet 11′, or of each of the further leading outlets 11′, is greater than or equal to about 15 mm, in particular to about 10 mm.

Advantageously, but not necessarily, (as in the embodiments illustrated in FIGS. 4, 5, 5A, 6, 7, 7A), a part of the leading outlets 11′ has a corresponding hole having a first (value of) equivalent diameter and at least a further part of such outlets 11′ has a corresponding hole having a second (value of) equivalent diameter, different from the (value of) first equivalent diameter. Alternatively (according to other advantageous but not limiting embodiments such as those illustrated in FIGS. 8, 9, 9A, 12 and 13), the respective hole of each of the second leading outlets 11′ is the same (i.e., has the same equivalent diameter) as that of the other leading outlets 11′.

Advantageously but not limitedly, the end portion 12 of the tubular discharge element 11 is configured to couple to the part 13 of the tubular casing 6; in particular, according to some non-limiting embodiments (such as those illustrated in FIGS. 2 to 11) the end portion 12 is configured to externally wrap around the part 13 of the tubular casing 6 so as to fluidically connect the tubular casing 6 of the electric heater 5 with the tubular discharge element 10 so that the gas G described above can flow inside the tubular discharge element 10; in other words, the tubular casing 6 fits into the tubular discharge element 10 at such end portion 12.

Advantageously but not necessarily, the tubular discharge element 10 has a circular cross-section, in particular with a constant diameter. In addition, advantageously but not necessarily, the tubular discharge element 10 is made in a single piece, particularly silicon carbide.

Advantageously but not necessarily, (also) the tubular casing 6 has a circular cross-section, in particular with a constant diameter.

According to some advantageous but non-limiting embodiments (such as those illustrated in FIGS. 2 to 9A, 12 and 13), the tubular discharge element 10 comprises a hollow main portion 17 extending, advantageously but not necessarily without interruption, from the end portion 12 to the end portion 14 and is configured to receive and be flown through by the gas G flowing out of the electric heater 5.

According to some advantageous but non-limiting embodiments (such as those illustrated in FIGS. 2, 3, 6, 7, 7A, 8, 9 and 9A) the end portion 14 comprises (in particular, defines) a taper 18 configured to guide the gas G from the hollow main portion 17 to the leading outlet 11.

The presence of the taper 18 further increases the speed of the gas G flowing out of the tubular discharge element 10, in particular from the outlet 11 and/or 11′ determining a further increase in the turbulent movements within the tubular discharge element 10 and facilitating, therefore, the heat exchange between the electric heater element and the gas G. Furthermore, such taper 18 implies a pressure drop, and therefore a flow rate drop, of the gas G which involves a further advantageous increase in the temperature of the gas G for the same amount of heat produced by the electric heater 5 due to the Joule effect.

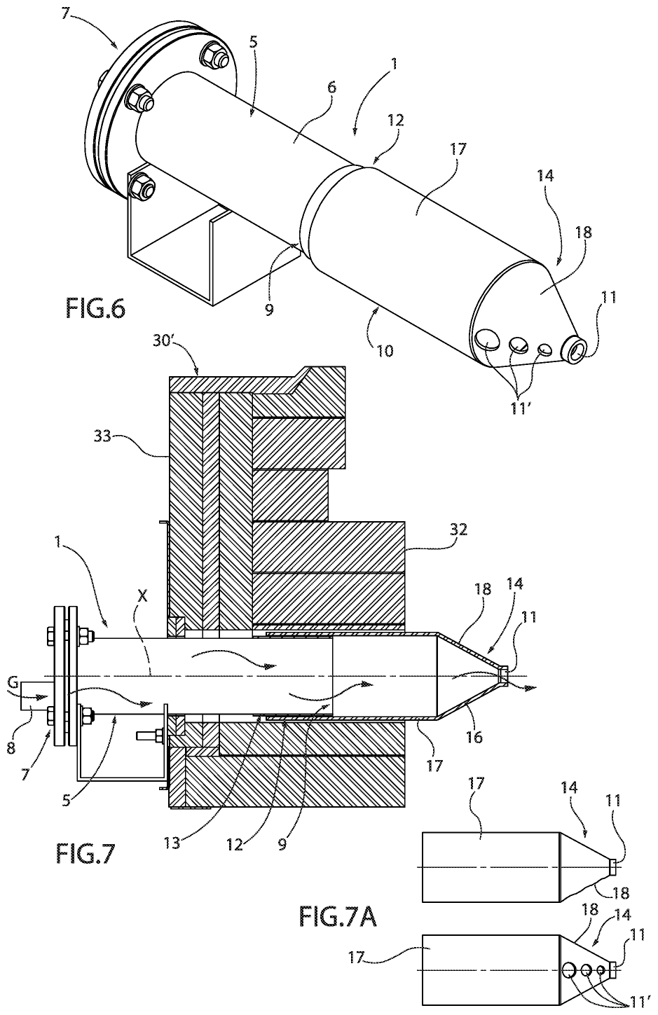

In detail, with particular reference to the non-limiting embodiment of FIGS. 6, 7 and 7A, the tubular discharge element 10 (at least at the hollow main portion 17) has a substantially circular cross-section and has, in addition to an outlet 11 arranged along the axis X of longitudinal symmetry of the tubular discharge element 10 a plurality of leading outlets 11′, e.g. 3 leading outlets 11′ as in the illustrated case, arranged on the wall 16 of the end portion 14, in particular of the taper 18, aligned with each other, and each having a through-hole with an equivalent diameter value different from the others; in particular, such leading outlets 11′ have through holes with increasing equivalent diameter values along the extension of the taper 18, i.e. passing through the main hollow portion 17 towards the outside.

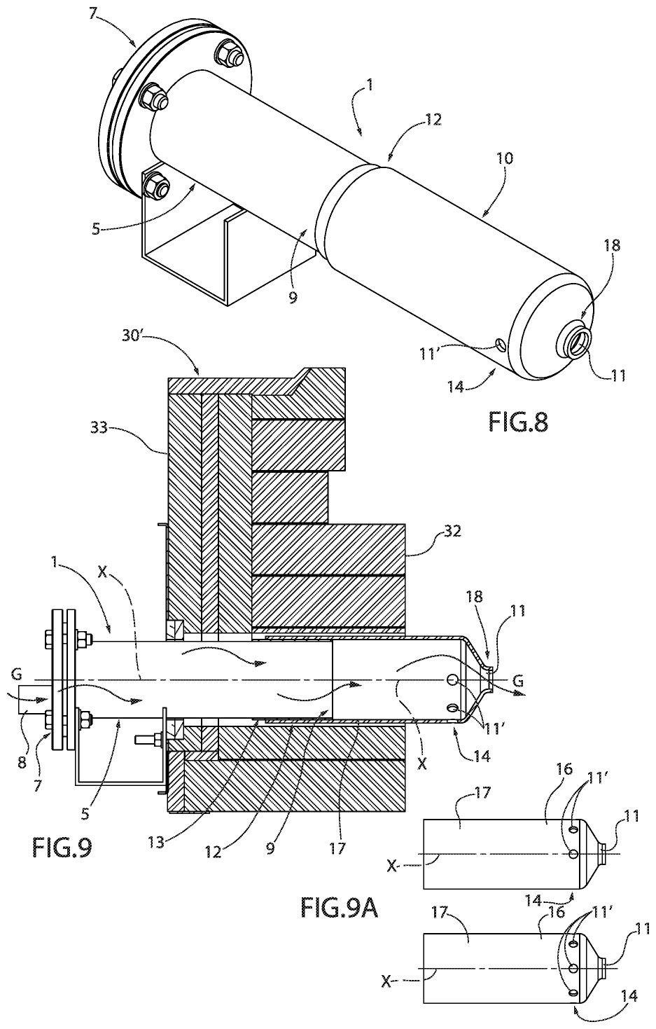

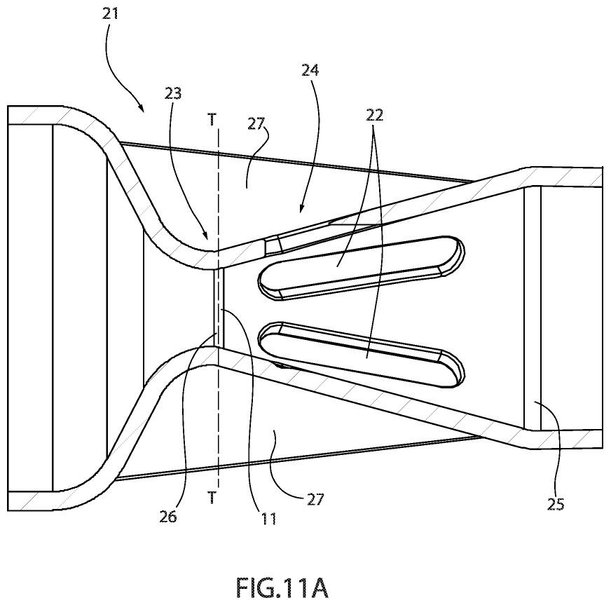

According to alternative non-limiting embodiments such as that illustrated in FIGS. 8, 9 and 9A, the tubular discharge element 10 has a substantially circular cross-section and has, in addition to the outlet 11 arranged along the axis X of longitudinal symmetry of the tubular discharge element 10, a plurality of outlets 11′ all having the same (value of) equivalent diameter arranged on the wall 16 of the end portion 14.

According to other non-limiting embodiments such s that illustrated in FIGS. 4, 5, 5A, the tubular discharge element 10 has a substantially circular cross-section and has a series of outlets 11, 11′ all arranged on the wall 16 of the end portion 14. Advantageously, a part of such leading outlets 11, 11′ has a first (value of) equivalent diameter and a second part of such outlets 11, 11′ has a second (value of) equivalent diameter, different from the first (value of) equivalent diameter; in particular, the outlets 11, 11′ having such first (value of) equivalent diameter and the outputs 11, 11′ having such second (value of) equivalent diameter are arranged alternately with each other.

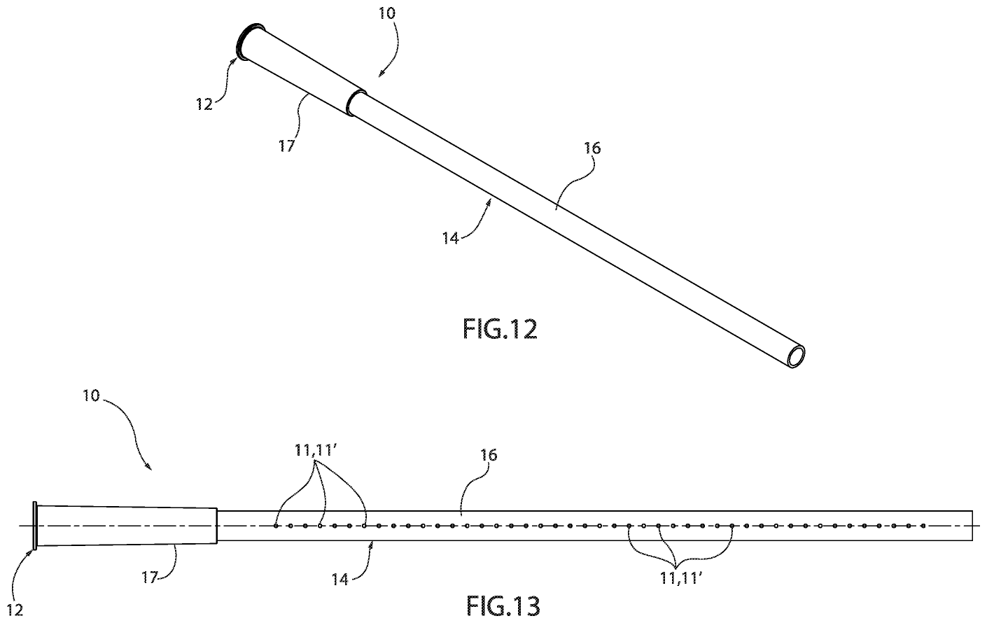

According to other advantageous but non-limiting embodiments such as that illustrated in FIGS. 12 and 13, the tubular discharge element 10 has a substantially circular cross-section and has a plurality of outlets 11 or 11′ arranged on the side wall 16 of the end portion 14 aligned with each other along a direction parallel to the axis X of longitudinal symmetry of the tubular discharge element 10 so that, in use, at least part of the gas G flows out of each of said outlets 11 or 11′ resulting in a series of parallel flows of gas G towards the outside, in particular towards the firing chamber 3.

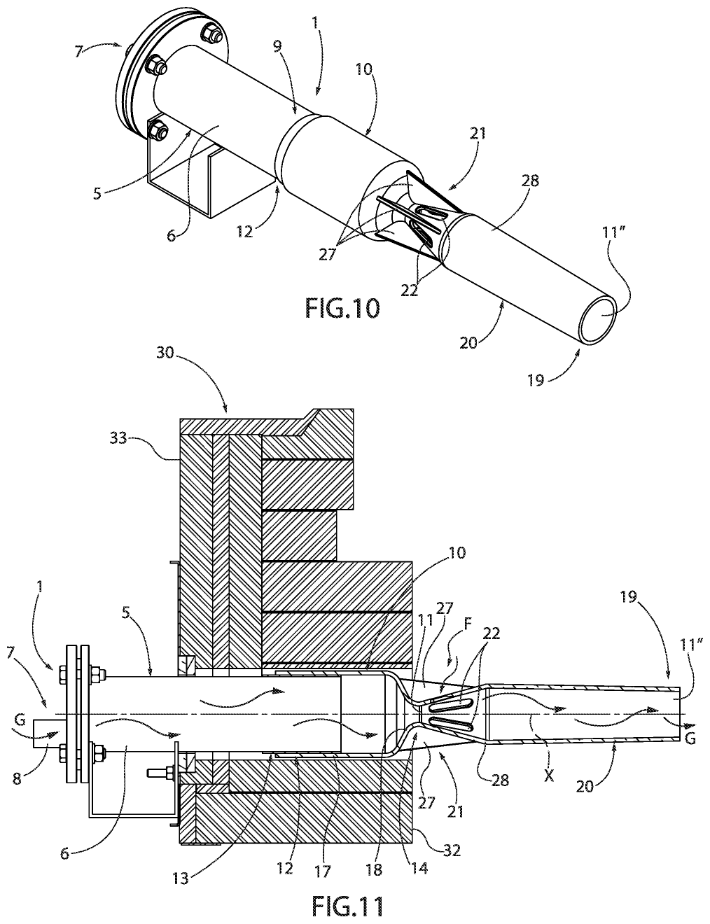

According to some advantageous but non-limiting embodiments (such as those illustrated in FIGS. 10, 11 and 11A), the heating assembly 1 further comprises: a hollow body 20 which is coupled to the tubular discharge element 10 so as to be flown through by (at least part of) the gas G flowing out of (via at least the inlet outlet 11) the tubular discharge element 10; a suction element 21, advantageously arranged between the tubular discharge element 10 and the hollow body 20; and a leading outlet 11″ for leading said at least part of said gas G towards the outside of the hollow body 20 (in particular, towards the outside of the heating assembly 1; even more particularly, in use, towards said firing chamber 3 of said kiln 2).

Advantageously but not limitedly, the leading outlet 11 is arranged on the hollow body 20, even more particularly along the axis X of longitudinal symmetry of the tubular outlet element 10, and is coaxial to the aforementioned leading outlet 11.

Furthermore, advantageously but not limitedly, such leading outlet 11″ has a through-hole with an equivalent diameter smaller than or equal to approximately 60 mm.

According to some non-limiting embodiments such as that shown in FIGS. 10, 11 and 11A, the hollow body 20 comprises an end portion 19 and, advantageously but not limitedly, such leading outlet 11″ is arranged on the hollow body 20 (in particular, at an end 19 of the hollow body 20; even more particularly, in use—i.e. when the heating assembly 1 is fitted in the kiln 2—facing inwardly the firing chamber 3).

Advantageously in this case, the tubular discharge element 10 is placed between the electric heater 5 and the suction element 21.

Advantageously, but not necessarily, and as illustrated in the non-limiting embodiment in FIG. 11, in use, the hollow body 20 is located (entirely) inside the firing chamber 3.

The suction element 21 is (advantageously but not limitedly) configured to bring, in use (i.e. when installed in the kiln 2), at least part of the waste gases F present outside the heating assembly 1 (in particular, outside the tubular discharge element 10) in the hollow body 20 and has one or more openings 22 arranged between the tubular discharge element 10 and the hollow body 20. The introduction of the waste gases F, already hot, which join the above-mentioned gas G inside the tubular discharge element 10, promotes the return of the gases F towards the kiln walls, as well as the heating of the gas G and the preservation of its speed and impulse towards the centre of the chamber of the kiln 2. In general, the gas turbulence of the fumes in the firing chamber 3 is increased improving the temperature uniformity across the width of firing chamber 3 of the kiln 2 and the heat exchange with the material.

Advantageously but not limitedly, the suction element 21 is configured to create a vacuum between the tubular discharge element 10 and the hollow body 20 so as to bring, in use, at least part of the waste gases F present in the firing chamber 3 into the hollow body 20. The introduction of the waste gases F, already hot, which join the above-mentioned gas G inside the tubular discharge element 10, promotes the heating of the gas G and increases the turbulence thereof.

Advantageously but not limitedly, the openings 22 extend through the suction element 21 (e.g., they have an elongated shape and are arranged longitudinally to the tubular discharge element 10 and the hollow body 20).

According to some non-limiting embodiments (such as the one illustrated in FIGS. 10 and 11), the tubular discharge element 10 is essentially coaxial to the hollow body 20. In other words, the axis X of longitudinal symmetry of the tubular discharge element 10 coincides with the axis X of longitudinal symmetry of the tubular discharge element 10 and hollow body 20.

According to some non-limiting embodiments, the suction element 21 comprises, in particular is, a Venturi tube.

Furthermore, according to some non-limiting embodiments (such as the one illustrated in FIG. 11A), the suction element 21 has a narrowing 23. In addition, the suction element 21 has a truncated cone-shaped section 24, delimited by a larger base 25 and a smaller base 26. More specifically, advantageously but not necessarily, the smaller base 26 coincides with the above-mentioned narrowing 23; the larger base 25 is coupled with the second hollow body 20. Advantageously, but not necessarily, the openings 22 are made on the truncated cone-shaped section 24 of the suction element 21. In particular, they cross from side to side (transversely) the truncated cone-shaped section 24 of the suction element 21.

Advantageously but not necessarily (and as illustrated in FIGS. 10, 11 and 11A), the suction element 21 comprises (also) reinforcing ribs 27. Thanks to these ribs 27, it is possible to lengthen the hollow body 20 as desired without the risk that the tubular discharge element 10 thus made breaks at the section with the smallest cross-section, i.e. at the suction element 21.

Advantageously, but not necessarily, the tubular discharge element 10 has a circular cross-section, in particular with a constant diameter.

Advantageously but not necessarily, the hollow body 20 has a circular cross-section, in particular with a constant diameter.

Advantageously, but not necessarily, the suction element 21 has a circular cross-section.

Advantageously, but not necessarily, the suction element 21 has a circular cross-section with a substantially variable diameter.

Advantageously, but not necessarily, the narrowing 23 i.e. the cross-section (FIG. 11A) of restriction 23 has a diameter smaller than two-thirds of the diameter of the tubular discharge element 10 and of the hollow body 20. More specifically, the cross-section TT (FIG. 11A) of the narrowing 23 has a diameter smaller than half the diameter of the tubular discharge element 10 and of the hollow body 20.

More specifically, advantageously but not necessarily, the narrowing 23, i.e. the cross-section TT (FIG. 11A) of the narrowing 23 has a diameter smaller than one-third of the diameter of the tubular discharge element 10 and of the hollow body 20. In particular, the cross-section TT of the narrowing 23 has a diameter greater than one-sixth of the diameter of the tubular discharge outlet 10 and of the hollow body 20.

Still more advantageously but not limitedly, the narrowing 23, i.e. the cross-section TT (FIG. 4) of the narrowing 23 has a diameter smaller than one third of the diameter of the tubular discharge element 10 and of the second hollow body 20.

In particular, in this case, advantageously but not limitedly, the narrowing 23 (i.e. the cross-section TT (FIG. 11A) of the narrowing 23) has a diameter ranging from approximately 10 mm (in particular from approximately 20 mm; more particularly from approximately 25 mm) to approximately 60 mm (in particular to approximately 40 mm; more particularly to approximately 35 mm. Advantageously, but not limitedly, the tubular discharge element 10 and the hollow body 20 have a diameter between approximately 30 mm (in particular, approximately 40 mm; more particularly, approximately 50 mm) and approximately 200 mm (in particular, approximately 120 mm; more particularly, approximately 100 mm).

The more the diameter of the narrowing 23 decreases, relative to the diameter of the tubular discharge element 10, the more the variation in the speed at which the gas G moves within the hollow body 19 increases. The increase in speed is advantageous both because it allows to let the gas G flow out with a greater speed, and because it increases the turbulence of the gas G within the heating assembly 1, advantageously improving the heat exchange between the gas and the electric heater element.

In the non-limiting embodiment of FIGS. 10, 11 and 11A, the tubular discharge element 10, the hollow body 20, and the suction element 21 form a single body, still more advantageously are made in a single piece, in particular of silicon carbide.

In particular, a side surface 28 of the tubular discharge element 10, of the hollow body 20 and of the suction element 21 is (at least) partially without interruption. More specifically, the side surface 28 is without interruption in the sections not interrupted by the openings 22 (see FIGS. 10 and 11).

Advantageously, but not necessarily, such single body (comprising the tubular discharge element 10, the hollow body 20 and the suction element 21) is made in a single piece, in particular of silicon carbide.

Alternatively, advantageously but not necessarily, such a single body (comprising the tubular discharge element 10, the hollow body 20 and the suction element 21) is made by additive manufacturing, in particular 3D printing. Alternatively, this single body is formed by welding the various constituent elements together, i.e. in this case, the tubular discharge element 10, the hollow body 20, and the suction element 21.

According to other non-limiting and non-illustrated embodiments, such a single body (comprising the tubular discharge element 10, the hollow body 20 and the suction element 21) is formed by mechanically coupling by means of fastening systems (e.g. bolts, screws, rivets, etc.) the various constituent elements, i.e., in this case, the tubular discharge element 10, the hollow body 20, and the suction element 21.

According to further non-limiting embodiments, such single body (comprising the tubular discharge element 10, the hollow body 20 and the suction element 21) is formed by means of mould casting techniques.

According to some not illustrated embodiments, the heating assembly 1 comprises a plurality of hollow bodies (similar to the hollow body 20) interspersed with corresponding suction elements (of the type of the suction element 21).

According to some not illustrated embodiments, the heating assembly 1 comprises a high-pressure fan to supply gas G (comprising, in particular, ambient air having at least 21% oxygen) to the electric heater 5. This advantageously allows to compensates for at least part of the pressure losses, and thus flow rate losses, of the gas G which arise as the gas G flows through the tubular casing 6 and the discharge element 10, thus preserving the flow rate thereof.

Referring in particular to FIG. 1, according to another aspect of the present invention, an industrial apparatus for the firing of ceramic articles T, referred to as number 29, is put forth.

The industrial apparatus 29 comprises a kiln 2 (as described above), in particular a tunnel kiln, having at least one side wall 30 and a roof or vault 31 delimiting a firing chamber 3 having a surface 32 inside the firing chamber 3 and a surface 33 outside the firing chamber 3.

In particular, the kiln 2 is advantageously tunnel-like with two opposite walls 30′ and 30″ forming the side wall 30, between which the ceramic articles T transit, and a roof or vault 31.

The industrial apparatus 29 further comprises a transport system 4 (as described above), in particular horizontal, which (as described above) is adapted to move a plurality of ceramic articles T along a conveying path P within the firing chamber 3 (from an inlet to an outlet of the firing chamber 3).

The transport system 4 may be any type of transport system.

Advantageously (as mentioned above), the transport system 4 comprises a series of rollers made of refractory material, on which the raw ceramic articles T to be fired are placed, preferably in an orderly fashion. More in detail (according to advantageous some but non-limiting embodiments), the transport system 4 comprises a plurality of ceramic rollers (possibly moved at different speeds to differentiate the firing of the articles) that define a conveying plane.

The apparatus 29 further comprises a heating system 34 (partially illustrated in FIG. 1) configured to heat the firing chamber 3 in order to fire the plurality of ceramic articles T passing within said firing chamber 3 and obtain finished ceramic articles, for example ceramic tiles.

Advantageously, the heating system 34 comprises at least one heating assembly 1. Even more advantageously, the heating system 34 comprises a plurality of heating assemblies 1 arranged in series along a direction parallel to the conveying path P.

More in detail, with particular reference to FIG. 1, advantageously, the heating assembly 1, in particular each heating assembly 1, is made as described above.

Advantageously, but not limitedly, the firing chamber 3 of the kiln 2 comprises (in particular, is divided into) at least one pre-heating area, one pre-firing area, one firing area and one cooling area arranged (one after the other) along the conveying path P. Advantageously, but not necessarily, the pre-heating area is connected to the pre-firing area and the firing area (without interruption), more specifically in a direct manner (i.e. without the interposition of further areas and/or chambers). Advantageously, the firing area and the cooling area are also, preferably but not necessarily, connected (without interruption), particularly in a direct manner (i.e. without the interposition of further chambers and/or areas).

In detail, within the pre-heating and pre-firing areas, the temperature of the ceramic articles T is gradually increased until a firing temperature of at least about 1100° C. is reached, in particular of at least about 1200° C., which is kept constant throughout the firing area; while within the cooling area, the temperature of the fired base ceramic articles BC exiting the firing area 6 is rapidly reduced.

Advantageously, but not limitedly, at least a part of the mentioned heating assemblies 1 is arranged at the pre-heating area (in particular, also in the pre-firing area) to heat at least the pre-heating area of said firing chamber 3 so as to impose within said pre-heating area a temperature of at least about 1000° C., in particular at least about 1100° C.

Advantageously, but not limitedly, according to some non-limiting and not illustrated embodiments, the heating system 34 of the apparatus 29 also comprises a plurality of electric radiant panels arranged within the firing chamber 3, in particular they are arranged on the surface 32 of the vault or roof 31 and above the surface of a bottom or sole or floor 35 of the firing chamber 3 of the kiln 2. The function of these radiant panels is to impose the above-mentioned firing temperature within the firing area itself. It is thereby possible to make an all-electric firing apparatus 29 for the firing of ceramic articles T, the benefit of which is a substantial reduction in CO2 emissions.

According to some advantageous but non-limiting embodiments, the heating assemblies 1 are arranged (i.e. they are mounted on the walls in the kiln) on several levels within the side wall 30 of the kiln 2; in particular of both the aforementioned side walls 30′, 30″ of the kiln 2.

In detail, advantageously, in the event that the transport system 4 comprises (consists of) ceramic rollers as described above, at least a part of the heating assemblies 1 is arranged below the conveying plane. The presence of the heating assemblies 1 also below the conveying plane enables a more uniform distribution of the heat within the firing chamber 3.

In combination (as illustrated in the non-limiting embodiments shown in FIG. 1) or alternatively, at least part of the heating assemblies 1 is arranged at the roof or vault 31 of the kiln 2. In detail, advantageously but not limitedly, the/each heating assembly 1 arranged on the roof or vault 31 is installed inclined with respect to the vertical and/or with respect to the conveying path P of the ceramic articles, in particular at an angle varying between about 0° and about 60° with respect to the vertical and/or at an angle varying between about 0° and about 60° with respect to the conveying path P.

Advantageously, the heating assemblies 1 are arranged (i.e. mounted) on the kiln 2 oriented in a direction that is transverse (i.e. perpendicular) to the advancement direction A (and thus to the conveying path P).

The counter current arrangement (i.e. orthogonal to the advancement direction of the ceramic articles T) of the heating assemblies 1 allows to avoid the risk that the gas jet G flowing out of the heating assembly 1 arrives directly at the ceramic articles T, with the consequent risk of damaging them.

Advantageously, but not necessarily, the/each heating assembly 1 is arranged (i.e. installed) in such a way that at least part of the tubular discharge element 10 protrudes at least partially into the firing chamber 3.

Still in more detail, according to some advantageous but non-limiting embodiments, the tubular discharge element 10 of the (i.e. of each) heating assembly 1 has a length of at least about 900 mm and the heating assembly 1 is installed in such a way that said discharge element 10 protrudes inside the firing chamber 3 by a length of at least about 600 mm.

According to still other advantageous but non-limiting embodiments such as the one illustrated in FIGS. 12 and 13, the tubular discharge element 10 is configured (in particular, it is dimensioned) in such a way that it crosses the firing chamber 3 transversally so that the leading outlets 11, 11′ described above are oriented towards the central part of the firing chamber 3. Still more particularly, in this case, the heating assembly 1 is installed in such a way that the tubular discharge element 10 can protrude from (i.e. flow out of) a first side of said side wall 30 (in particular, from the wall 30′), extend through said firing chamber 3 to a second side, opposite to the first side (in particular, to the wall 30″). Advantageously, in this case, the tubular discharge element 10, in particular, its end portion 14 crosses the entire firing chamber 3 and fits into the side wall 30″.

Advantageously, but not limitedly, the/each heating assembly 1 is arranged (i.e. installed) so that the electric heater of the (in particular, of each) heating assembly 1 extends at least partially (in particular, totally) through the (in particular, transversely) side wall or roof or vault 31 of the kiln 2 or between the inner and outer surface of the firing chamber 3.

According to some advantageous but non-limiting embodiments (e.g. illustrated in FIGS. 10 to 13), when the heating assembly 1 comprises (in particular, is also formed by at least) the hollow body 20 and the suction element 21 as described above, the heating assembly 1 is installed so that the suction element 21 is arranged, at least partially, within the firing chamber 3.

Alternatively or in combination, advantageously, but not limitedly, in this case (when the heating assembly 1 also comprises the hollow body 20 and the suction element 21 as described above), the heating assembly 1 is installed so that the electric heater 5 extends at least partially (in particular, totally) through (in particular, transversely) the side wall 30 or the roof or vault 31 of the kiln 2 between the inner surface 32 and the outer surface 33; the tubular discharge element 10 extends at least partially (in particular, totally) through (in particular, transversely) the side wall 30 or the roof or vault 31 of the kiln 2 between the inner surface 32 and the outer surface 33; and the hollow body 20 extends substantially completely within the firing chamber 3.

According to some non-limiting and non-illustrated embodiments, advantageously but not necessarily, the heating assembly 1 is installed so that the tubular discharge element 10 protrudes at least partially into the firing chamber 3.

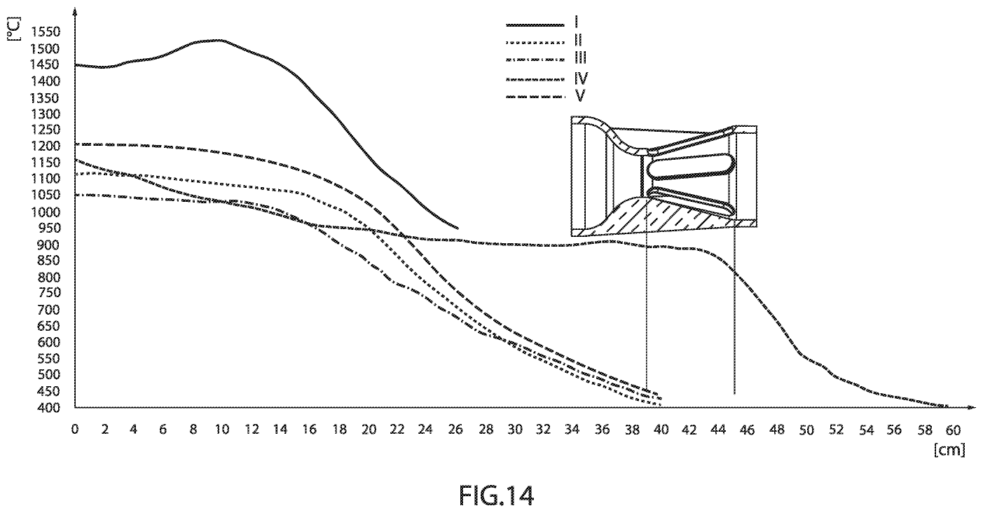

In the graph in FIG. 14, the temperature trend is shown as a function of the distance from the outlet 11 of the heating assembly such 1; graph was obtained experimentally. In particular, the axis of the ordinate indicates the temperature inside the firing chamber 3 and the axis of the abscissa indicates the distance from the leading outlet 11 of the heating assembly 1, coinciding with the side wall of the kiln 2. In detail, the variation in temperature indicated with line I refers to an apparatus 29 with high-speed gas burners of the known type, while the variation in temperature indicated with lines II and III refers to an apparatus 29 with heating assemblies 1 both having an electric heater 5 of the type described above but a tubular discharge element 10 with an outlet 11 having a through-hole with an equivalent diameter (increasing from line II to line III but) greater than about 25 mm, while the temperature variation indicated with lines IV and V refers to an apparatus 29 and a heating assembly 1 made according to two different embodiments of the invention (in particular, line V refers to a heating assembly 1 having a tubular discharge element 10 with an outlet 11 having a through-hole having an equivalent diameter of about 25 mm and line IV refers to a heating assembly 1 also having a hollow body 20 and a suction element 21). It is therefore apparent that, by using an apparatus 29 and a heating assembly 1 according to the present invention, more uniform and constant temperature values are obtained than those of known apparatuses having gas burners within a certain distance from the walls 32 of the kiln 2. In fact, a normal gas burner may have a more or less enhanced “hot spot” depending on the architecture of its combustion head. Reducing the equivalent diameter of the through-hole of the outlet 11 causes the increase of back pressure of the gases G flowing out of the outlet of the section 11, thus increasing the temperature and speed of the gas G flowing out of the heating assembly 1 and thus causing the firing chamber 3 to heat more uniformly.

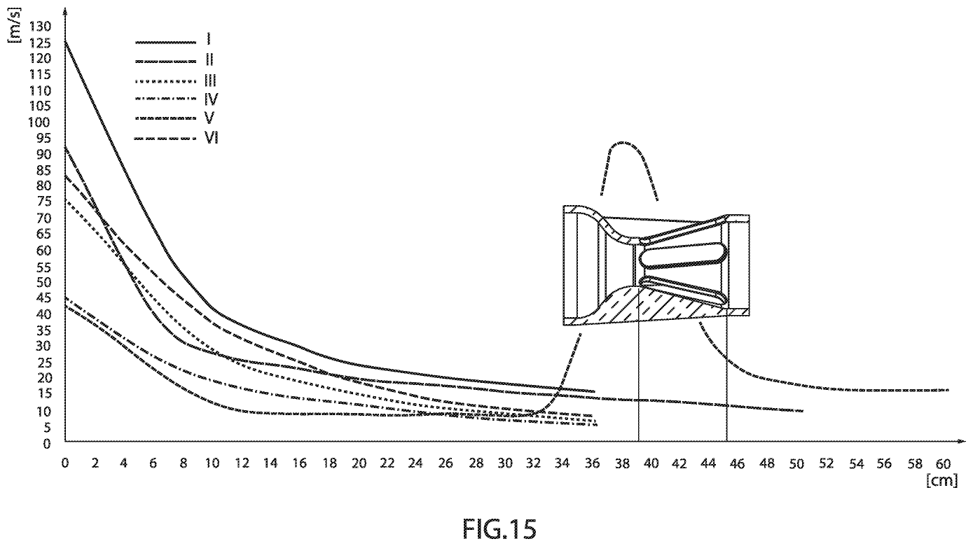

In FIG. 15, lines I and II refer to apparatuses with gas burners of the known type, lines III and IV refer to apparatuses 29 with heating assemblies 1 both having an electric heater 5 of the type described above but a tubular discharge element 10 with an outlet 11 having a through-hole with an equivalent diameter (increasing from line III to line IV but) greater than about 25 mm, while lines V and VI refer to an apparatus 29 and to a heating assembly 1 made according to one of two embodiments of the invention (in particular, line VI refers to a heating assembly 1 having a tubular discharge element 10 with an outlet 11 having a through-hole with an equivalent diameter of about 25 mm and line V refers to a heating assembly 1 also having a hollow body 20 and a suction element 21). Such figure shows the trend of the flame speed (for lines I and II) or of hot gases G (for lines III, IV, V and VI) inside the firing chamber 3 as a function of the distance from the outlet 11 of the heating assembly 1, coinciding with the side wall of the kiln 2.

This graph was also derived experimentally. Also from this graph it follows that the narrowing of the equivalent diameter of the through-hole of the leading outlet 11 causes the increase of the back pressure of the gases G flowing out of the leading outlet 11, increasing its temperature and the flowing-out speed of the gas G, which becomes more similar to that produced by an architecture already known in the literature with a high-speed gas burner (curves I and II). Furthermore, from the graph in FIG. 15 it follows that the presence of the suction element 21 promotes an abrupt increase in speed by promoting its retention towards the centre of the firing chamber 3 of the kiln 2. Although the above-described invention refers in particular to some well-defined embodiments, it is not to be considered as limited to such embodiments, all those variants, modifications or simplifications covered by the appended claims falling within its scope, such as, for example, a different geometry of the tubular discharge element 10 and/or of the leading outlets 11, 11′, 11″, of the suction element 21, a different arrangement of the heating assemblies 1 within the apparatus 29 (both as position and as alignment), a different transport system 4, etc.

The apparatus 29 and the heating assembly 1 described above have many advantages.

The main advantage of the apparatus 29 and heating assembly 1 of the present invention lies in the reduction of CO2 emissions and consumption of non-renewable raw materials, resulting in clear environmental benefits.

Furthermore, the use of an electric heater 5 such as the one described above allows for a more precise control of the temperatures within the firing chamber 3 at least in the area having the heating assemblies 1 described above, as well as an increase in safety due to the at least partial overcoming of all safety drawbacks related to combustion.

Compared to the known methods and systems for electrically heating kilns for firing ceramic articles T, the heating assembly 1 of the invention enables ceramic articles T to be heated more effectively and uniformly along their entire cross-section. This enables an optimal firing of ceramic articles up to about 15 mm thick, in particular up to about 10 mm.

Furthermore, with the heating assembly 1 and the apparatus 29 of the invention, the occurrence of fumes inside the firing chamber 3 is limited and therefore also the risk of particulate deposition on the ceramic articles T is reduced, with the consequent reduction in the risk of damaging the articles themselves.

In addition, the heating assembly 1 of the present invention, given its geometry and penetration into the firing chamber 3, may safely be installed in place of a standard gas burner architecture of the kiln 2.

The following aspects of the invention are also provided (alternatively or additionally).

A heating assembly (1) for the firing of ceramic articles (T), which is installable in an industrial kiln (2) comprising a firing chamber (3); the heating assembly (1) comprises:
an electric heater (5) comprising, in turn, a tubular casing (6) having, at an end (7) a feeding duct (8) to feed a gas (G) comprising (in particular, consisting of) ambient air into the tubular casing (6), at least one electric heating element, which extends inside the tubular casing (6) and can be operated in order to heat said gas (G); and
a tubular discharge element (10) which extends from said tubular casing (6) on the opposite side relative to said feeding duct (8) and is configured to receive and be flown through by said gas (G) flowing out of said electric heater (5);
a hollow body (20), which is coupled to said tubular discharge element (10) and is intended to be flown through by at least part of said gas (G) flowing out of said tubular discharge element (10);
a suction element (21), which is arranged between said tubular discharge element (10) and said hollow body (20), is provided with one or more openings (22) and is configured to bring, in use, at least part of the waste gases (F) present inside said heating assembly (1) (in particular, inside the firing chamber (3)) into the hollow body (20); and
a leading outlet (11″) to lead at least part of said gas (G) to the outside of the hollow body (20) (in particular, to the outside of said heating assembly (1); even more particularly, in use, towards said firing chamber (3) of said kiln (2)).

2. The heating assembly (1) according to aspect 1, wherein: the tubular discharge element (10) comprises a first end portion (12) coupled to a part (13) of said tubular casing (6), a second end portion (14) opposite to the first end portion (12) coupled to said hollow body (20) and a further leading outlet (11) arranged at said second end portion (14) along an axis (X) of longitudinal symmetry of said tubular discharge element (10) for fluidically connecting said tubular discharge element (10) and said hollow body (20); and

the hollow body (20) comprises an end portion (19); and said leading outlet (11″) is arranged at said end portion (19) along said axis (X) of longitudinal symmetry of the tubular discharge element (10).

3. The heating assembly (1) according to aspect 1 or 2, in which the leading outlet (11″) has a through-hole with an equivalent diameter smaller than or equal to approximately 60 mm; in particular, said further leading outlet (11) has an equivalent diameter smaller than approximately 25 mm.

4. The heating assembly (1) according to any one of the preceding aspects, wherein the suction element (21) is configured to create a vacuum between the tubular discharge element (10) and the second hollow body (20) so as to bring, in use, at least part of the waste gases (F) present in the firing chamber (3) into the hollow body (20); and said openings (22) extend through the suction element (21) (e.g. they have an elongated shape and are arranged longitudinally to the tubular discharge element (10) and the second hollow body (20)).

5. The heating assembly (1) according to any one of the preceding aspects, wherein the tubular discharge element (10) is coaxial to said hollow body (20) and the suction element (21) comprises a Venturi tube.

6. The heating assembly (1) according to any one of the preceding aspects, wherein:
the suction element (21) has a narrowing (23) and a truncated-cone shaped section (24), delimited by a larger base (25) and a smaller base (26);
the smaller base of said truncated cone-shaped section (24) coincides with said narrowing (23); the larger base (25) of said truncated cone-shaped section (24) is coupled to said hollow body (20); in particular, the suction element (21) comprising reinforcing ribs (27).

7. The heating assembly (1) according to aspect 6, wherein the narrowing (23) has a diameter smaller than one-third of the diameter of the tubular discharge element (10) and the second hollow body (20); in particular, the narrowing (23) has a diameter ranging from about 10 mm (in particular, from about 20 mm; more particularly, from about 25 mm) to about 60 mm (in particular, from about 40 mm; more particularly, to about 35 mm).

8. The heating assembly (1) according to aspect 6 or 7, wherein the tubular discharge element (10) and the second hollow body (20) have a diameter between approximately 30 mm (in particular, approximately 40 mm; more particularly, approximately 50 mm) and approximately 200 mm (in particular, approximately 120 mm; more particularly, approximately 100 mm).

9. An industrial apparatus (29) for the firing of ceramic articles (T) comprising: a tunnel kiln (2) provided with at least one side wall (30) and a roof/vault (31), which at least partially delimit a firing chamber (3) having an inner surface (32) and an outer surface (33); a transport system (4), which is configured to move a plurality of ceramic articles (T) along a conveying path (P) inside the firing chamber (3); and a heating system (34), which is configured to heat said firing chamber (3) so as to fire said plurality of ceramic articles (T) moving through the inside of said firing chamber (3) and obtain ceramic products (PC);

the kiln (2) being characterized in that said heating system (34) comprises at least one heating assembly (1) according to any one of the preceding aspects 1 to 8.

10. The industrial apparatus (29) according to aspect 9, wherein said heating assembly (1) is installed so that said suction element (21) is, at least partially, inside the firing chamber (3).

11. The industrial apparatus (29) according to aspect 9 or 10, wherein said (in particular, each) heating assembly (1) is installed in such a way that said electric heater (5) extends at least partially (in particular, totally) through (in particular, transversely) the side wall (30) or the roof/vault (31) of the kiln (2) between said inner surface (32) and said outer surface (33); said tubular discharge element (10) extends at least partially (in particular, totally) through (in particular, transversely) the side wall (30) or the roof/vault (31) of the kiln (2) between said inner surface (32) and said outer surface (33); and the hollow body (20) extends substantially completely within the firing chamber (3).

12. The industrial apparatus (29) according to any one of aspects 9 to 11, wherein said heating assembly (1) is installed so that the tubular discharge element (10) protrudes at least partially into the firing chamber (3).

13. The industrial apparatus (29) according to any one of aspects 9 to 12, wherein: said heating system (34) comprising a plurality of heating assemblies (1) arranged in series along said conveying path (P); a part of said plurality of said heating assemblies (1) is arranged at said roof/vault (31) of the kiln (2); and each heating assembly (1) of said part of the plurality of the heating assemblies (1) is installed inclined with respect to the vertical and/or with respect to the conveying path (P), in particular by an angle varying between about 0° and about 60° with respect to the vertical and/or by an angle varying between about 0° and about 60° with respect to the conveying path (P).

14. The industrial apparatus (29) according to aspect 13, wherein: said firing chamber (3) of said kiln (2) comprises (in particular, is divided into) at least one pre-heating area, a pre-heating area immediately downstream of the pre-heating area along said determined path (P), a firing area downstream of the pre-heating area along said determined path (P), and at least one cooling area downstream of the firing area; and said plurality of heating assemblies is arranged at least at said pre-heating area (in particular, also in said pre-heating area) to heat at least said pre-heating area of said firing chamber (3) so as to impose a temperature of at least about 1100° C., in particular at least about 1200° C.

15. The industrial apparatus (29) according to any one of the aspects from 9 to 14, wherein: said transport system (4) comprises a series of ceramic rollers arranged one after the other along said conveying path (P) so as to define a conveying plane suited to receive said ceramic articles (T) and move them along said conveying path (P); and at least part of the heating assemblies (1) are arranged under said conveying path.

16. A heating assembly for the firing of ceramic articles (T), which is installable in an industrial kiln comprising a firing chamber; the heating assembly comprises:
an electric heater comprising, in turn, a tubular casing having, at a first end a feeding duct to feed a gas (G) comprising ambient air into the tubular casing, at least one electric heating element, which extends inside the tubular casing and can be operated in order to heat said gas (G); and
a tubular discharge element, which extends from said tubular casing on the opposite side relative to said feeding duct, is configured to be flown through by said gas (G) flowing out of said electric heater and comprises at least one first leading outlet to lead at least part of said gas (G) towards the outside of the tubular discharge element (in particular, towards the outside of the heating assembly; more in particular, in use, towards said firing chamber of said kiln), which first leading outlet has a through hole with an equivalent diameter smaller than or equal to approximately 25 mm.

17. The heating assembly according to claim 16, wherein:
the tubular discharge element comprises:
a first end portion, which is coupled to a part of said tubular casing, and
a second end portion, which is opposite the first end portion; and
said at least one first leading outlet is arranged at said second end portion.

18. The heating assembly according to claim 17, wherein:
said first leading outlet is arranged along a longitudinal symmetry axis (X) of said tubular discharge element; and
said second end portion comprises, in particular, defines, a taper to guide said gas (G) towards said at least one first leading outlet.

19. The heating assembly according to claim 17, wherein said at least one first leading outlet is arranged on a wall of said second end portion.

20. The heating assembly according to claim 17, wherein:
said tubular discharge element comprises at least one second leading outlet to lead at least part of said gas (G) towards the outside of the tubular discharge element; and
the at least one second leading outlet has a respective through-hole having an equivalent diameter smaller than or equal to approximately 25 mm and is arranged at said second end portion.

21. The heating assembly according to claim 20, wherein said at least one second leading outlet is arranged on a wall of said second end portion.

22. The heating assembly according to claim 16, wherein:
said tubular discharge element comprises a plurality of second leading outlets arranged on a wall at least of said second end portion so as to lead at least part of said gas (G) towards the outside of the tubular discharge element;
in particular, towards the outside of the heating assembly; and
more in particular, in use, towards said firing chamber of said kiln), each one of said second leading outlets having a respective through hole with an equivalent diameter smaller than or equal to approximately 25 mm.

23. The heating assembly according to claim 22, wherein:
a first part of said second leading outlets have a corresponding hole having a first equivalent diameter; and
at least a second part of said second leading outlets have a corresponding hole having a second equivalent diameter, different from the first equivalent diameter.

24. The heating assembly according to claim 16, further comprising:
a hollow body, which is coupled to the tubular discharge element so as to be flown through by at least part of said gas (G) flowing out of the tubular discharge element, a suction element and a further leading outlet to lead said at least part of said gas (G) towards the outside of the hollow body, in particular, towards the outside of the heating assembly, more in particular, in use, towards said firing chamber of said kiln;
the suction element being arranged between the tubular discharge element and the hollow body, being provided with one or more openings and being designed to bring, in use, at least part of the waste gases (F) present inside the firing chamber into the hollow body.

25. An industrial apparatus for the firing of ceramic articles (T) comprising:
a tunnel kiln provided with at least one side wall and a roof/vault, which at least partially delimit a firing chamber having an inner surface and an outer surface;
a transport system, which is configured to move a plurality of ceramic articles (T) along a conveying path (P) inside the firing chamber; and
a heating system, which is configured to heat said firing chamber so as to fire said plurality of ceramic articles (T) moving through the inside of said firing chamber and obtain ceramic products;
wherein said heating system comprises at least one heating assembly according to claim 16.

26. The industrial apparatus according to claim 25, wherein said heating system comprises a plurality of heating assemblies arranged in series parallel to the conveying path (P).

27. The industrial apparatus according to claim 25, wherein:
a part of said plurality of heating assemblies are arranged at roof/vault of the kiln;
each heating assembly of said part of said plurality of heating assemblies is installed inclined relative to the vertical (direction) and/or relative to the conveying path (P), in particular at an angle ranging from approximately 0° to approximately 60° relative to the vertical (direction) and/or at an angle ranging from approximately 0° to approximately 60° relative to the conveying path (P).

28. The industrial apparatus according to claim 25, wherein:
each heating assembly is arranged so that at least part of said tubular discharge element at least partially projects into the firing chamber;
in particular, the tubular discharge element of said heating assembly has a length of at least approximately 900 mm and each heating assembly is installed so that the tubular discharge element projects into the firing chamber for a length of at least approximately 600 mm, more in particular said tubular discharge element is configured so as to cross said firing chamber crosswise.

29. The industrial apparatus according to claim 25, wherein:
said firing chamber of said kiln comprises at least one pre-heating area, a pre-firing area immediately downstream of the pre-heating area along said conveying path (P), a firing area downstream of the pre-firing area along said conveying path (P) and at least one cooling area downstream of the firing area along the conveying path (P); and
said plurality of heating assemblies is arranged at least at said pre-heating area in order to heat at least said pre-heating area so as to reach a temperature of at least approximately 1000° C., in particular at least approximately 1100° C.

30. The industrial apparatus according to claim 25, wherein:
said transport system comprises a series of ceramic rollers arranged one after the other along said conveying path (P) so as to define a conveying plane suited to receive said ceramic articles (T) and move them along said conveying path (P); and
at least part of the heating assemblies is arranged under said conveying path.
